(19) United States
(12) Patent Application Publication
(10) Pub. No.: US 2009/0188916 A1
(43) Pub. Date: Jul. 30, 2009

(54) Insulated Housing

(76) Inventor: William A. Daviau, Brevard, NC (US)

Correspondence Address: DOUGLAS T. JOHNSON;MILLER & MARTIN, 1000 VOLUNTEER BUILDING, 832 GEORGIA AVENUE, CHATTANOOGA, TN, 37402-2289, US

(21) Appl. No.: 12/411,966

(22) Filed: Mar. 26, 2009

Related U.S. Application Data
(63) Continuation-in-part of application No. 12/048,884, filed on Mar. 14, 2008.
(60) Provisional application No. 60/986,183, filed on Nov. 7, 2007.

(51) Int. Cl. H02G 3/08

(52) U.S. Cl. 220/3.2

(57) ABSTRACT

A wall component for use in building structures preferably provides a rear panel which is insulated. This panel preferably provides an improved R value to the housing which has traditionally been a thermal short in many applications. The panel preferably extends significantly beyond a perimeter of the cavity of the housing on three sides. A fourth side of the housing may have a side insulating panel connected thereto to assist in preventing thermal shorts. Finally, an air seal can be provided between dry wall and a flange extending around no more than three sides of the housing.

### CLAIM OF PRIORITY

This application is a continuation in part of U.S. patent application Ser. No. 12/048,884 filed Mar. 14, 2008, which claims the benefit of U.S. Provisional Patent Application No. 60/986,183 filed Nov. 7, 2007.

### FIELD OF THE INVENTION

The present invention relates generally to addressing heat transfer losses through exterior walls of structures from conditioned air spaces at specific locations and more specifically to improved insulation techniques incorporated into or used with components that have traditionally been associated with localized areas of energy loss such as electrical boxes or dryer ducts, and more specifically to those components having an improved panel at a rear of the component and/or improved airtight mechanism, and at least in some cases, as an integral part thereof.

### DESCRIPTION OF RELATED ART

Electrical boxes have been utilized in homes and businesses since the electrification of America in the early part of the 20^{th} century. These boxes currently provide a mounting for electrical outlets, electrical switches, computer network outlets, cable television outlets, and for certain alarm wiring. The boxes are typically hollow metal or plastic rectangles or squares though they can and do take other shapes for certain applications. These boxes are typically attached to a wall stud on one side and surrounded by insulation materials in accordance with the accepted building codes on the top, bottom, and side away from the stud, the space behind the electrical box is typically an open air space stopping at the inside face of the exterior wall. A cover plate is typically attached to the front of the box and an after market gasket is available for attaching to the reverse side of the cover plate certain configurations to prevent unconditioned airflow into the conditioned area.

There are certain problems associated with electrical boxes, they are not insulated and consequently, they afford an easy path for heat loss from the conditioned space and for heat gain when the conditioned space is cooled during the hotter time of the year. Heat transfer to the outside of the conditioned area is enhanced by active convective heat transfer behind the box. The space behind the box is difficult to insulate even when the insulation installer has the best of intentions and when that installer does make the effort to insulate behind the box there is not sufficient room to maintain the thermal barrier using the fibrous insulation available at the jobsite.

Examples of patented devices which may be attempting to address this energy loss include U.S. Pat. No. 6,874,295 to Anderson, U.S. Pat. No. 4,667,840 to Lindsey, U.S. Pat. No. 4,616,104 to Lindsey, U.S. Pat. No. 6,103,381 to Keith, and U.S. Pat. No. 5,771,645 to Porter.

While these devices might be suitable for some purposes, none are believed to be built into or otherwise satisfactory for the electrical box to afford uniformity of design and function.

Thomas & Betts, Inc. has a line of NuTek® Airtight plastic switch and outlet boxes that have four hinged cable entry tabs which are covered with an airtight foam gasket material which is apparently adhered in rectangular pieces to exterior portions of the boxes. While this is an improvement over other non-airtight box constructions, it is believed to be somewhat awkward to manufacture, and if the adhesive were to fail, the gasket would become detached from the box.

In addition to energy loss through electrical boxes, the applicant has discovered energy is routinely lost through dryer vent connections. Dryer ducts often pass through an exterior wall and have a vent cover with a flapper which is normally pivotably connected so that it is shut when the dryer is not in use. When the dryer is in use, then the outlet flapper pivots allowing dryer exhaust to exit the space. Dryer vents, such as are shown in U.S. Pat. No. 5,916,023 have a unitary molded flapper. There is ample opportunity for heat loss through the flapper or possibly other component of a dryer vent which could otherwise be better insulated to prevent heat loss.

### BRIEF SUMMARY OF THE INVENTION

It is an object of the present invention to provide an improved insulation panel for use with at least one of an electrical box or dryer vent flappers in an effort to conserve energy.

It is another object of the present invention to provide an improved electrical box for minimizing energy loss from conditioned spaces.

It is another object of the present invention to provide an improved dryer vent construction.

Accordingly, an insulation panel for an electrical box or dryer vent or the like is believed to substantially depart from the prior art and in doing so, provides an insulation function with an electrical box or other structure to be provided by the manufacturer in most instances.

In view of the disadvantages of wasting the energy to condition air, namely the energy lost through heat transfer which is subsequently discharged into the atmosphere and the ongoing need to conserve energy where it can be conserved, the present invention allows for said energy to be more efficiently contained in the conditioned space and to do so without significant additional labor or expense on the jobsite preferably taking full advantage of the efficiencies of manufacture.

One purpose of the presently preferred embodiments of the invention is to slow the passage of heat from a conditioned space to the wall cavity and subsequently to the atmosphere through a technology that is not believed to be mentioned or suggested by any of the known prior art or in any available electrical boxes or dryer vents.

Specifically, in the presently preferred embodiments, a panel at the rear of the box and/or flapper of the dryer vent is a preferred beginning point which may incorporate one or more insulating portions, possibly including gas or vacuum in the panel or flapper. Additionally, an optional radiant barrier may be incorporated with the appropriate box or flapper used. The panel is preferably configured to extend a distance beyond the box in at least two, if not three, directions to assist in apparently forcing flow of heat around the panel. Significantly lower R values were achieved with the preferred construction than with similar insulated panels terminating at the edges of the box. The presently preferred embodiments of the present invention are believed to reduce energy loss through fixtures mounted on exterior walls such as when the air is conditioned inside of the building.

### BRIEF DESCRIPTION OF THE DRAWINGS

The particular features and advantages of the invention as well as other objects will become apparent from the following description taken in connection with the accompanying drawings in which:

FIG. 1 shows a top perspective view of the presently preferred embodiment of the present invention;

FIG. 2 is a front plan view of the electrical box shown in FIG. 1;

FIG. 3 is a cross sectional view taken along line A-A of FIG. 1 of the presently preferred embodiment;

FIG. 4 is a cross sectional view taken along line B-B of FIG. 1;

FIG. 5 is a cross sectional view of a first alternative embodiment of an electrical box slightly different from the embodiment shown in FIG. 1 as would have been taken along the line B-B of FIG. 1;

FIG. 6 is a cross sectional view of a second alternative embodiment of an electrical box slightly different from the embodiment shown in FIG. 1 of FIG. 5 as would have been taken along line B-B of FIG. 1;

FIG. 7 is a detailed cross sectional view of the portion C shown in FIG. 4;

FIG. 8 shows a cut away perspective view of the details shown in FIG. 7;

FIG. 9 is a top perspective view of a third alternative embodiment of the present invention;

FIG. 10 is a cross sectional view taken along the line D-D of FIG. 9;

FIG. 11 shows a cross sectional view of a fourth alternatively preferred embodiment in the form of a dryer vent;

FIG. 12 shows a cross sectional view of a fourth presently preferred embodiment similar to the view shown in FIG. 10;

FIG. 13 is a fifth alternative embodiment of the presently preferred embodiment of the present invention;

FIG. 14 is an exploded side view of a box with an alternatively preferred embodiment;

FIG. 15 is a front plan view of the box of FIG. 14 with the front gasket removed;

FIG. 16 is a side view showing the gasket of FIGS. 14 and 15 installed;

FIG. 17 is a front plan view of an alternative box in the presently preferred embodiment; and

FIG. 18 is a cross sectional view taken along the line of E-E of FIG. 17.

### DETAILED DESCRIPTION OF THE DRAWINGS

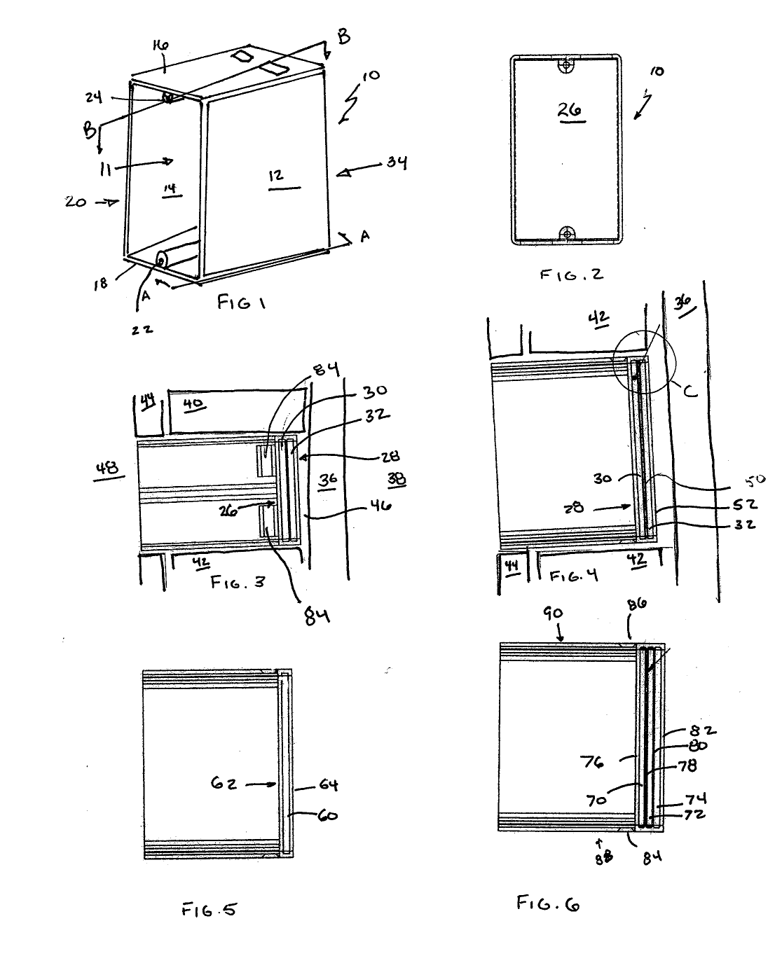

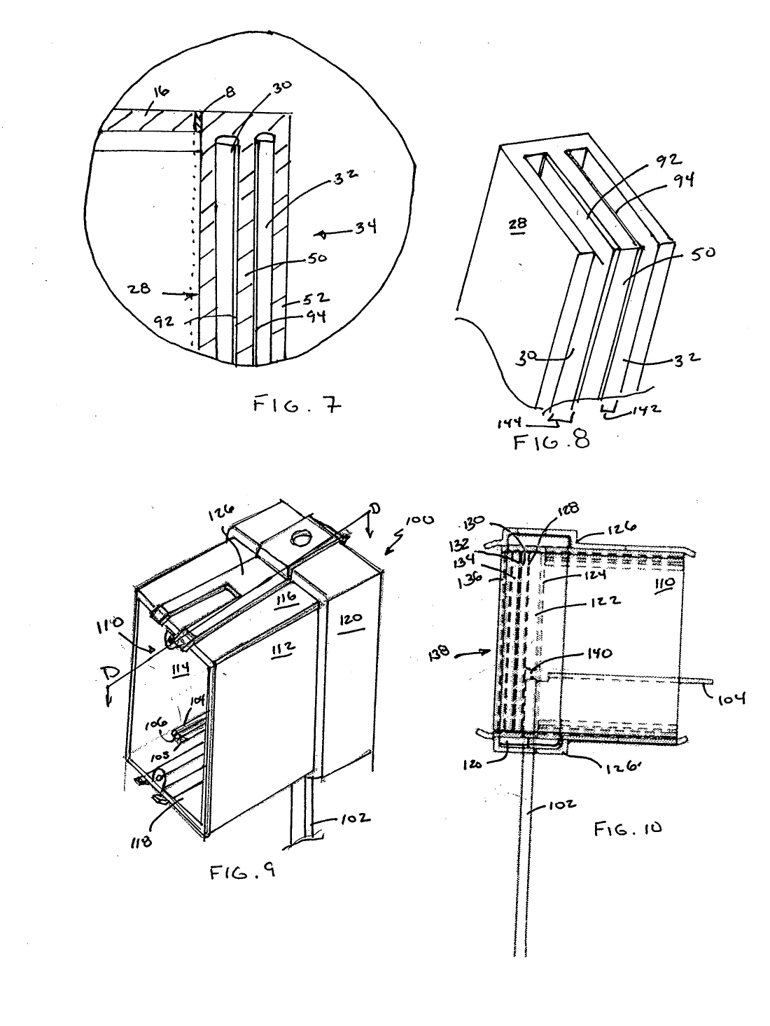

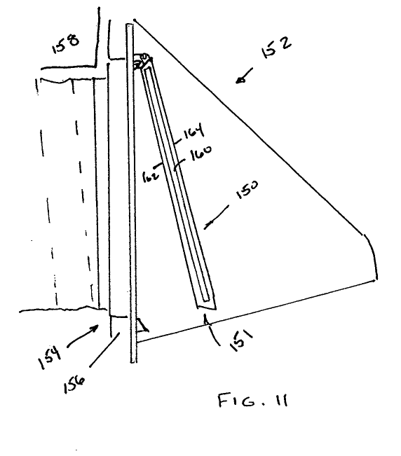

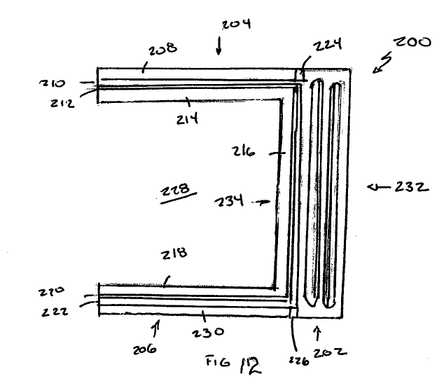

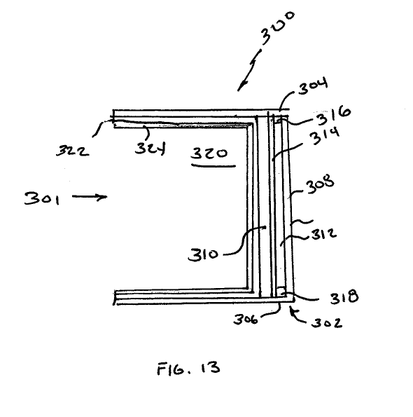

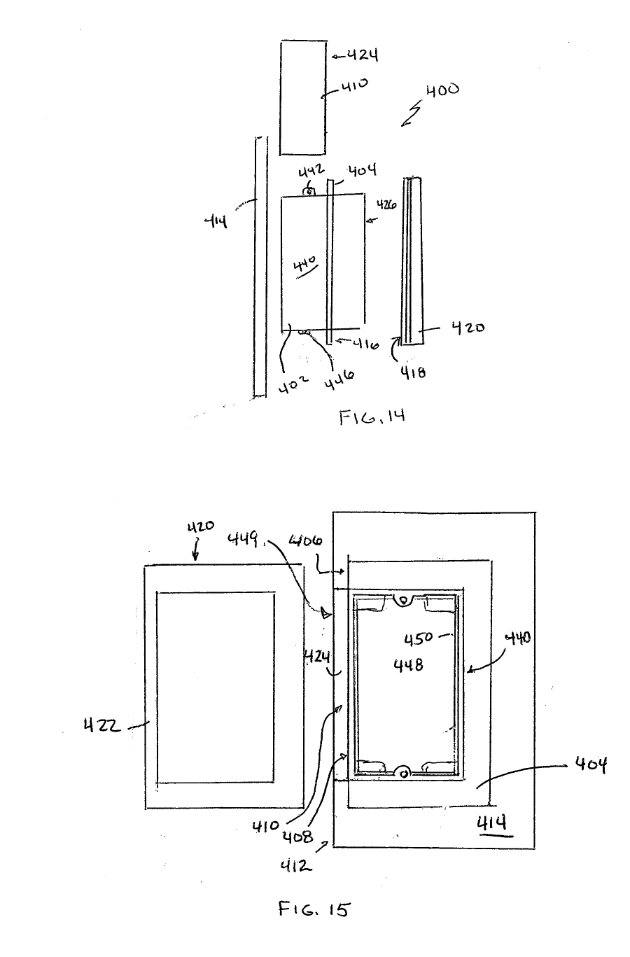

FIG. 1 is a top perspective view of a presently preferred embodiment of an electrical box 10. This electrical box 10 is designed to replace at least some prior art boxes which have been utilized for many years. Specifically, the prior art style boxes are traditionally utilized to house outlets, switches, such as on/off switches for lighting, computer network outlets, cable television outlets, alarm and/or door bell wiring connections throughout their structures. This one is shown as a single gang box. Those skilled in the art will understand that the invention herein can be applied to double, triple, etc., gang boxes as well as electrical service boxes, etc.

The box 10 illustrated has first side 12, second side 14, top 16, and bottom 18. Other box styles may have additional and/or other structure. Front 20 is usually provided with an open space into a cavity 11 which receives one of a switch and outlet, wire connection or other structure therein as would be understood of ordinary skill in the art. An installer may connect things within and/or to the box 10. Access is provided through front 20 although access may be provided through other portions in other embodiments. After a desired connection and/or installation is provided, a cover plate (not shown) is usually put on the front of the box 10. Bores 22,24 are normally provided at top 16 and bottom 18 as shown to receive threads of a screw through a component such as a double 120V outlet or receptacle (not shown) into box 10.

A rear wall 26 behind cavity 11 as shown in FIG. 2 may have a different construction than prior art construction techniques which can better be understood with reference to other figures. Specifically, FIG. 3 is a cross section taken along line A-A of FIG. 1. Rear wall 26 is actually comprised of an insulation panel 28 having at least one void or chamber 30 therein with chamber 30 having a gas, air and/or at least a partial vacuum therein extending at least substantially across the cavity 11. The void is preferably at least 0.16 inches wide and is anticipated being about 0.25 inches wide or possibly wider. Any width, even less than 0.16 inches is contemplated for the chambers 30,32 depending upon the design objectives to be met. FIG. 3 shows two such voids or chambers 30,32. The insulation panel 28 has been found to significantly reduce the transfer of heat through the rear 34 of the box 10. Specifically, a conditioned space 48 such as a room or other space where the air in that room is treated to be either warmed or cooled relative to an exterior, outside or other environment 38 which would normally believed to be located opposite a wall 36 is illustrated in FIG. 3.

Normally, the box 10 is connected to a stud 40 which could be a 2×4 or other structure and the box 10 is normally nailed or screwed thereto during installation. Opposite the box 10 from the stud 40 is normally insulation 42. Insulation 42 is also normally located above and below the box 10 as shown in FIGS. 3 and 4. Sheet rock 44, paneling or other structure is normally located in front of the insulation 42. A hole is typically cut out or otherwise provided for access for the box 10. As one can see with reference to FIG. 3 and 4 in the absence of an attempt at insulating the box 10, there would otherwise potentially be a significant thermal short through that structure through air space 46 exterior wall 36 to the environment 38 from an interior space 48. Insulation 42 may take many forms as is known in the art whether provided in rolls or blown or otherwise provided for to meet current building codes and/or desired energy objectives.

Chambers 30,32 could be filled with air, insulating gas such as argon or Krypton and/or other appropriate insulating gasses such as but not limited to Krypton. Furthermore, chambers 30,32 may be at least a partial vacuum relative to the conditioned air space 48. Aerogel, foam, fibrous insulation and/or other insulator could also be provided in chambers 30,32 as well as portions of additional or other layers such as spacer 8 which could be a gasket as illustrated or layer (as shown in phantom in FIG. 7). Insulated panel 28 may be comprised of a rear wall 26, first chamber 30, first intermediate wall 50 and exterior wall 52 preferably spaced by second chamber 32 as illustrated in FIG. 4. This is a dual or double chamber insulating layer 28. The chambers 30,32 are preferably air tight which is meant to mean not allowing movement of air into or out of the chambers 30,32 or even a sealed cavity.

FIG. 5 shows a slightly different embodiment with a single chamber 60 defined intermediate rear wall 62, an exterior and back wall 64. FIG. 6 is a slightly different embodiment which is a three chamber embodiment having first, second and third chambers 70,72,74 defined by rear wall 76, first intermediate wall 78, second intermediate wall 80 and exterior wall 82. Wire passages 84,86 as shown in FIG. 3 are located at the bottom 88 and/or top 90 of the box 10.

A more detailed view of the embodiments of FIG. 1-4 is shown in detail in FIGS. 7 and 8. Specifically rear wall 28 is shown along with first intermediate wall 50 and exterior wall 52 being spaced apart by first chamber 30 and second chamber 32. Also, first radiant barrier 92 is illustrated oriented towards the front 20 of box 10. First radiant barrier 92 may be a shiny aluminum or other material related design to reflect radiant heat rather than allowing it to transmit therethrough. Second radiant layer 94 may be useful to permit radiant transmission heat from the rear 34 towards the front 20 of the box 10.

FIG. 8 is a cutaway perspective view of the structure shown in FIGS. 3, 4 and 7 showing the first and second radiant layers 92,94 connected to first intermediate layer 50. It would be understood by one of ordinary skill in the art that the second radiant layer 94 is normally disposed pointed at exterior wall 52. Second radiant layer is envisioned being utilized in multiple chamber constructions such as two or more, but could be utilized in single chamber embodiments. First radiant layer 92 which reflects radiant energy towards rear wall 28 may be utilized in any or all embodiments.

While the embodiment of FIGS. 1-8 provide for a way to run wire or cable into box 10 from the top 16 and bottom 18 of the box 10, through wire passages such as 84,86 to provide at least one way to run wire into cavity 11 from a back portion of an electrical box. FIG. 9 provides an alternative embodiment of box 100 with wire 102 shown running therein with wire ends 104,106,108 being disposed within the cavity 110 of the box 100 as defined by sides 112,114 as well as top and bottom 116 and 118. As shown in FIG. 10, the wire 102 passes through first gasket 120 and into channel 122 and is then directed through interior wall 124 which forms a back of the cavity 110. Clips 126 and 128 are useful to maintain at least one gasket 120 in a desired position. Multiple gaskets 120 may be provided in other embodiment. In the illustrated embodiment, gasket 120 is a band-like structure that goes about sides 112,114 top and bottom 118 of box 100.

Behind interior wall 124 is located rear wall 128, first chamber 130, first intermediate wall 132, second chamber 134 and exterior wall 136 which provide the insulation panel 138 in not too different construction in this illustrated embodiment than is shown and described above for FIGS. 1-4 and 7-8. Rear wire 102 can be seen entering sleeve 140 and turning into cavity 110 as wire end 104 in FIG. 10. Other methods of providing a way to provide insulation panel 138 behind an electrical box 100 may also be provided in other embodiments.

With reference to the various embodiments, the more chambers such as one, two, three or more and that are provided such as are illustrated in the various figures, the lower U value that may be achieved. This may translate into more insulating capability that the panels such as 28 and 138 may provide. A potentially unlimited number of chambers can be provided in various embodiments to create a desired insulation effectiveness within an available spacing. Trial and error may assist in selecting the widths 142 and 144 of channels such as 30,32 shown in FIG. 8. The applicant is at this time testing 0.25 inches for widths 142,144 as this provides for a double chamber construction that fits well within a width of a 2×4 stud (3.5 inches) when the box 10 has at least somewhat traditional interior dimensions.

Although the box 10 and 100 are illustrated as being 2¼ inches wide and 1½ inches deep, a depth of roughly 2¾ inches, there still remains roughly ¾ of an inch of open space 46 which can be utilized for the panels 28,138 and/or spacers 8, if utilized, while providing boxes 10,100 which can be utilized as effectively on exterior walls to significantly increase the R-value at these specific locations. Applicant has found that an R-value of R-13, R-15 or R-19 can be achieved with the various embodiments of the structure as shown and described herein when utilized with standard installation techniques with the box 10 connected to a stud 40 and insulation 42 located around the top 16, bottom 18 and sides 12,14. The R value of the box 10 above is estimated to be about R4, R6, R10 or possibly R12 or higher in some embodiments. Although the additional effort at providing the insulated panel 28 or 138 will possibly contribute to a slightly higher cost of production than a single uniform thickness rear wall 28 located at the exterior wall of a housing as has been known in the prior art, the energy savings alone in a single year for most applications are believed to more than recover the increased costs of manufacturing. Due to the ability to mass produce these boxes 10 and 100, the cost of production over a larger number of units should decrease rapidly to an extremely affordable price point. Furthermore, although an insulation panel 28 or 138 could be connected to existing or other boxes with or without spacer 8 in some embodiments, by providing this structure as a manufactured box 10 or 100 as illustrated, a uniformity not believed to have been made available to builders of prior art alternatives should now exist in the marketplace.

Although the insulation panels 28 and 138 are shown sized to correspond to the perimeter dimensions of first and second sides 12,14 and top and bottom 16,18, insulation panels 28,138 could be different sizes based on the objectives of the manufacturer and/or the builder.

The boxes 10 and 100 may be constructed of metal, plastic and/or other appropriate materials and the gasket 120 is anticipated to be manufactured out of a resilient material to allow wire 102 to pass therethrough as would be understood by those of ordinary skill in the art. The gasket 120 of the presently preferred embodiment will be described in further detail below.

Panel 28 may be connected to the top 16, bottom 18 and sides 12,14 such as with one or more insulating spacers 8 such as a gasket or spacing layer preferably made of foam, fibrous materials such as fiberglass, rock wool, etc. Spacer 8 shown in FIG. 7 is useful at least in some embodiments. Metal normally conducts heat very well and if the box 10 were completely made of metal, a metal connection at spacer 8 may otherwise cause a thermal short. Spacers 8 could be sufficiently wider to fill up the 3.5 inch space such as ½ inches or more when taken together with panel 28 and the rest of the box dimensions in some embodiments. This may eliminate the possibility of convection through air space 46 shown in FIG. 3 and may provide additional insulation effectiveness. Other embodiments can employ chambers 30, 32 in top 16, bottom 18 and/or sides 12,20. Plastic is a presently preferred material for construction of box 10 while other materials which are known in the art could also be utilized.

Gasket 120 is a presently preferred method of sealing against wire 102 when inserted into box 100. Gasket 120 may be a resilient piece that is connected to the box possibly having an inside and an outside layer with an activatable gel between the two layers such that when wire is pushed through the gasket 120 the gel contacts the wire 102 and box 110 sealing off air movement into or out of the box 110. The gel may cure upon exposure to air. Other ways of using a gel or other air seal on wire 102 may also be utilized. In addition to sealing the movement of air at connections where wire 102 passes into box 136.

In addition to significantly reducing the transmission emission of heat either into or out of the conditioned space 48, insulating panel 28 is also believed to reduce noise transmission therethrough which is believed to be an added benefit especially in many residential and other structures.

The embodiments disclosed herein are of the presently preferred embodiments. It may be that with further experimentation and construction that additional layers may be added on either side of the insulating panel 28 or even within such as a chamber spaced by insulating strips of fiberglass followed by another chamber and an exterior wall, etc. Furthermore, it may be that some of the chambers are filled with various solids and/or gasses such as fiberglass or foam in a first chamber with a radiant strip as shown in FIG. 8 (without showing the foam or fiberglass in the first chamber 30 and the second chamber constructed similarly or differently to chamber 32 as illustrated).

FIG. 11 shows an alternative embodiment of a panel 150 used as a flapper 151 or at least a portion of a flapper 151 for a vent 152 for a dryer connection 154 connected to an exterior wall 156. Although insulation 158 is normally useful in addressing heat loss through wall 156, when the flapper 151 with the panel 150 is in a shut position, the flapper 151 of the presently preferred embodiment offers a panel 150 provides more insulation than a solid metal or plastic flapper as has been provided in prior art constructions. Flapper 151 has panel 150 as a part thereof, but could be connected thereto with or without a spacer depending on the particular objectives and design criteria. Panel 150 can take the various constructions similar or dissimilar constructions as panel 28 (i.e., single, double, triple or more chamber construction).

Once again, with relatively minor or initial expense, a significantly more energy efficient dryer vent 152 can be provided to the market. The chamber such as chamber 160 is illustrated spaced between front wall 162 and exterior wall 164 can also be provided with various insulation, insulating gasses and/or at least a partial vacuum to attempt to minimize heat transfer therethrough as described above for panel 28.

FIG. 12 shows a fourth alternative embodiment of an electrical box 200 having a presently preferred rear panel 202 connected to box top 204 and box bottom 206, the sides (not shown) being similarly or dissimilarly constructed. The box top 204 has top 208 illustrated with one or more insulation layers 210 and 212. Layer 210 preferably is an insulation layer such as a layered fiberglass insulation made by Silvercote or others including, but not limited to, Rock Wool with insulation layer 212 possibly being a radiant barrier such as aluminum. The combined thickness of the insulation layers 210 and/or 212 in a preferred embodiment is roughly 0.10 inches or so and may have an individual R-value such as R-5. However, other R-values for the insulation layer or layers 210,212 may also be provided in other embodiments.

Optional internal top 214 is illustrated connected to internal wall 216 which is illustrated connected the internal bottom 218. Internal top, wall and bottom 214,216,218 can be used to protect layers like layer 212 during installation of wires at least in some embodiments. Radiant barrier 220 is shown connected to insulation layer 222 at the bottom member 206 with similar construction separating internal rear wall 216 from panel 202 possibly in conjunction with or instead of spacers 224,226 if utilized. Sides are envisioned as being similarly constructed although are not required to be.

In one test performed by applicant, the embodiment of FIG. 12 was tested with absence of the R-5 insulation layers as comprised of layers 210,212,220,222 and the like and resulted in an effective value of R-2 due to thermal energy from air cavity 228 passing into walls such as sides, top 208 and box bottom 206 and finding a least resistance heat transfer path through solid portions of the box 200 to find its way to the rear 232 of the electrical box 200 thereby providing an unintended thermal short. This thermal short gave rise to initial R-value of 2 in initial testing. By providing insulation such as insulation layers 210 and 212 having an insulation value of R-5, the collective R-value was increased to R-11, R-13 or even better.

It is important to remember that internal box members 214,216,218 are optional and in addition to optional insulation layers 210,212 as well as corresponding structure disposed towards the rear 234 and/or towards the bottom wall of the structure can be provided along the side walls which will be understood by those of ordinary skill in the art. The internal box members 214,216,218 are useful to protect the radiant barrier 212,220 when utilized to prevent wires from scraping through it during use or during installation.

During testing, the panel 202 achieved an R-value of R-30 or better, but it was desirable to prevent the thermal shorts from the sides, top wall 208 and bottom wall 230 to provide an overall R-value at an acceptable level. The illustrated embodiment of FIG. 12 has achieved at least an R-11 to R-13 level, but other insulation techniques possibly with higher insulative capabilities on sides and top may be achievable.

FIG. 13 shows yet another embodiment of the present invention that has been developed during attempts at improving mass production techniques of a box 300. Rear panel 302 is constructed utilizing a portion of top 304, bottom 306, sides (not showing) and back 308. One or more dividers 310 are inserted from the front 301 to define void 312 intermediate divider 310 and back 308. The divider 310 may have a radiant barrier 314 thereon. Spacers 316 and 318 may be utilized to ensure desired placement of divider 310 during installation. Additional dividers 310, possibly along the spacers 316,318 and/or radiant barriers 314 such as are oriented and as are shown in FIG. 13 or other drawings may also be provided. Furthermore, the divider(s) 310 can be retained in detents or other locating mechanisms relative to the top 304, bottom 306 and/or sides (not shown). After installing a desired number of dividers 310, in some embodiments it may be desirable to provide insulation layers to separate at least a portion of the cavity 320 from at least portions of divider 310, top 304, and bottom 306. Insulation layers are shown as insulation layer 322 and/or radiant barrier 324 which need not necessarily be provided in all embodiments.

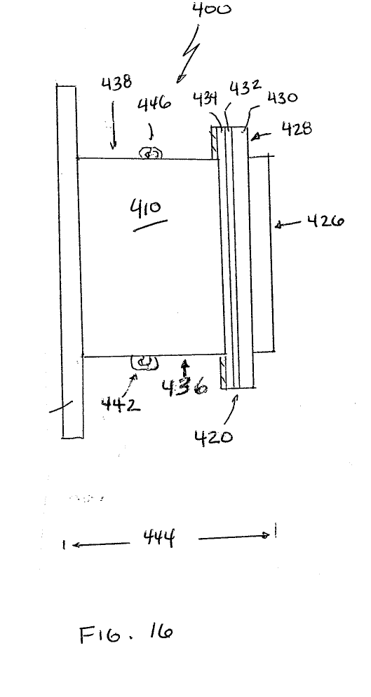

FIG. 14 shows another alternatively preferred embodiment of a box configuration 400 in an exploded view. Specifically, housing 402 is preferably provided with flange 404. As can be seen in FIG. 15, flange 404 in a preferred embodiment extends no further than edge 406 which corresponds to a side edge 408 of housing 402. This is distinguishable from the NuTek device in which the flange extends on all four sides of the housing 402. It may be possible in other embodiments to extend the flange 404 past the edge 408 in other embodiments and even extend along edge 408 in such embodiments, however, it is preferable that flange 404 will not extend past side insulation panel 410 and/or side edge 412 of rear panels 414.

With all the NuTek® designs, those boxes have flanges which extend further than the side edges of box panels which connect to a stud. This means that the flanges must extend in front of the stud members like 2×4 or 2×6 which the applicant believes creates an awkward situation. Instead of then being able to mount sheet rock directly against those studs, it will be necessary for the sheet rock to be displaced by the distance of the flange and the compressed gasket at that location which would appear to interfere with the flushness of the sheet rock panel across the wall.

The applicant's flange and gasket configuration is believed to be significantly different to that of the NuTek® airtight box models. Flange 404 provides a front face 416 to which a rear 418 of air seal 420 can rest when installed. Air seal is preferably a foam material.

Unlike the NuTek® device advertised by Thomas & Betts as fitting only ½ inch sheet rock, the applicant's design is configured to fit with a single air seal 420 is configured to fit ⅜, ½ and ⅝ inch sheet rock. This is performed by providing an air seal 420 of a foam construction of a desired compressibility whereby in a ⅜ inch dry wall construction the seal would be slightly loose but still performing the sealing function. With ½ inch dry wall, the connection would be tighter, and with ⅝ inch sheet rock, the construction would be tighter still. The apparent slim profile of the gasket utilized with the prior art device would appear to prevent such a flexibility. Although three sides of the air seal 420 is supported by flange 404 in a preferred embodiment, the fourth side 422 may be supported by front face 424 of side insulation panel 410 which is where the stud connects as would be understood by those of ordinary skill in the art particularly when FIGS. 14-16 are compared to FIGS. 1-13.

Front face 416 of flange 404 when utilized is spaced an appropriate distance as would be understood by one of ordinary skill in the art from front 426 to accomplish the necessary sealing of gasket 420 relative to dry wall when installed as described above. The gasket 420 preferably has an uncompressed thickness of roughly ½ an inch. When connected to housing 402 as is shown in FIG. 16, prior to compression by dry wall preferably leaves slightly less than ⅜ inch spacing from front face 428 to front 426.

Air seal 420 may or may not be a laminated foam product having a first portion 430 having a first compressibility, a second portion 432 having a second compressibility, and a third portion 434 having a third compressibility. In the preferred embodiment, the first and third portions 430,434 have a similar compressibility which is more compressible than second portion 432. This construction has been found to provide increased insulation tendencies as well as increased air sealing characteristics particularly through the wide range of possibilities (i.e., up to ¼ inch difference from ⅝ inch to ⅜ inch dry wall). Foam in portion 432 is more dense than that provided by first and third portions 430,434 in a preferred embodiment. Other embodiments may have other design characteristics.

As one can see from reference to FIGS. 14-16, in combination with those of the other figures already provided, air seal 420, if utilized, when cooperating with dry wall will prevent the flow of air around the face 426 of the box configuration 400 and the dry wall. At least some additional insulating characteristics should also be experienced.

In order to get to a preferred R-13 construction, the applicant discovered that when the box configuration 400 was connected to a stud for at least some constructions, heat had a tendency to go around some of the prior art panels through walls of the housing 402. In order to prevent this from adversely affecting R-values for some embodiments, panel 414 was constructed which can be a similar panel as those provided in the other illustrated embodiments.

Specifically, 414 construction in accordance with a presently preferred embodiment is a panel having at least one of insulation material therein and a vacuum. In the preferred embodiment, the panel 414 has a thickness of roughly about ¼ inch if not about 0.4 inches. Other thicknesses could be provided with other embodiments. The applicant has taken 0.4 inch aerogel with an R-4 value and vacuum compressed it into panel 414 which is a thickness of 0.4 inches thus providing an R-10 insulation value. Other thicknesses and R-values may be possible with other embodiments possibly using other materials including but not limited to fiberglass, rockwool, perlite and/or other materials. Furthermore, as can be seen by the attached drawings, the panel 414 extends a distance beyond top 436, bottom 438 and/or side 440. In fact, it has been found that a distance of approximately 1.3 inches has been found desirable. Panel 414 can extend a distance, such as is at least about ½ inch, if not about ¾ or one inch, if not about 1.3 inches beyond the top 436, bottom 438 and side 440. In the preferred embodiment, heat shorts go around the panel 414 have been greatly reduced. As it relates to the heat passing by side edge 408 illustrated in FIG. 15, side panel 410 has been found helpful to provide an insulated value of R-4 from front to back which is believed to assist in preventing a thermal short in that direction.

Panel 414 can achieve up to R-8 for a 23 cubic inch single gang box using an extruded board insulation piece as a panel 414. In other tests, an R rating of R-35 has been achieved utilizing a partially evacuated panel (i.e., under vacuum) containing aerogel. Various other R-values have been achieved using a partially evacuated panel containing fiberglass, finely ground perlite, and/or other base materials.

When the applicant says under vacuum, it is not contemplated to be a complete vacuum as such a condition can place significant stress on the structural internal portions of the panel. A relatively low vacuum can be provided because it can cost significantly less to construct a material that houses the vacuum. Extreme evacuation of internal gasses while providing a more insulative effect is typically has cost benefit tradeoffs that relates to the amount of vacuum. By substituting higher costs and insulation elements within panel 414 such as aerogel which is relatively expensive for lower cost filament materials which would otherwise require more intense levels of vacuum that uses the same R value, the applicant can provide a desired R rating with an acceptable amount of vacuum. Of course, high vacuum pressures can be provided with other embodiments, if so desired.

A very strong vacuum has been found to not work particularly well in that the internal pressure in the container walls of prototypes constructed by the applicant were not typically well supported by insulating film materials. If support is provided, then the structural support can conduct heat which could dilute the purpose of the insulating panel 414. Furthermore, in a strong gas vacuum, collectants, getters, and dissectants are typically employed to absorb inevitable moisture and air leakage into the vacuum chamber. In many instances, the thinner the walls of the panel 414, the higher R value that can be achieved.

In addition to a radiant barrier 450, low emission coatings can also be in place whether in the cavity 448 or external to the housing such as on the opposing side 440 covered by insulation panel 410, top 436 or bottom 438 or other appropriate location.

With the R values discussed in this application, it should be understood that testing methods endeavor to measure heat transfer through a material. This testing is evaluated from the front to the back, from the top to the bottom. However, those of ordinary skill in the art will know that heat moves in multiple directional flow. The only real constant is that heat seeks cold. The testing criteria employed by most testing laboratories including those utilized by the applicant do not fully accommodate the mechanism of heat transfer and may not translate to actual values achieved by a home owner or other uses.

In many of the embodiments tested by the applicant, no matter how well the back panel was insulated, particularly if it did not extend past the cavity, testing could not be passed due to thermal shorts which would effectively be created along the sides. This led to the development of an oversized panel 414 for at least some embodiments and the use of side insulation panels. The applicant found that in real world applications and not during testing environments, heat would move along the side of the box through the wall insulation for at least a short distance and then enter the box and move along the walls of the box or interior the box and out to the colder side.

Oversized panel 414 can serve to force that heat to migrate through the wall insulation in a circuitous route back to the sides of the box or to outside sheeting depending on which side is hotter. In this manner, wall insulation can be utilized to assist in achieving the thermal performance at the level of the box, particularly where the wall insulation overlaps the panel 414 exterior to the cavity 448.

Of course, insulating the walls (i.e., sides, top and bottom) is also an option whether it be through the various insulation panels or as like the back panel 414 or the other panels shown and described in this application.

On the stud side which is side 449, a partially evacuated thermal panel could be utilized with or in place of panel 410. Such a panel could achieve R-7 or higher, and possibly even up to R-25. A current building code as understood by the applicant makes a specific allowance for reduced R value at the level of the stud. For at least the illustrated embodiment, a ⅛ inch EPS board, foam insert, or other product that tests for R-value from the front to the back and does not achieve a significantly high R value to the front of the box to the stud has been employed. Other embodiments may have a significantly higher R value at the stud location as it relates to side to side heat transfer.

Panel 414 extends to the side 449 of side panel 424 in a preferred embodiment. Fourth side 422 of air seal 420 also extends to the side 449 of side panel 410. This way the preferred embodiment provides a flush edge along side 449 as can be understood with reference to FIGS. 15 and 16, which for preferred embodiments are believed to facilitate installation in a new header.

The housing 402 in the form of a box configuration 400 provides an R-value of at least about R-6 and preferably is at about R-13. This is consistent with current wall insulation that surround the electrical box. The panel 414 provides at least one of a partial vacuum pressure, air, an insulating gas, aerogel, fibrous insulation, fiberglass and foam therein and has a thickness of no more than about half an inch. Other embodiments of housings 402 could be electrical boxes for a switch or electrical connection, communication signal connections, outlets and/or dryer vent exhaust.

In the embodiment illustrated, the panel 414 extends out beyond at least half of the perimeter of the cavity which could be evaluated as a top and a side in the illustrated embodiment of FIGS. 14-16. Other cavities may have other perimeters in which the panel may extend appropriately therebeyond in other embodiments. In fact, in the illustrated embodiment, the panel 414 extends at least ¾ of an inch beyond at least ⅔ of the perimeter of the housing of the components such as box configuration 102.

The flange 404 preferably extends no further past housing on three sides than a distance of the panel 414 extends past the housing 402. The air seal shown further provides a continuous perimeter about the housing 402 and provides a seal which could be selected from dry wall, any of which from a group of ⅜, ½ inch and ⅝ inch.

Nail guides 442,446 may be useful to assist in connecting the box to configuration 400 to a stud at an appropriate location.

Although the panel is shown connected to the panel 414 as shown connected to the housing 402, it need not necessarily be connected directly thereto or even connected at all in some embodiments. The panel 414 as constructed will work for its intended purpose whether to the box housing 402 forming the box 400 or not. While the preferred construction includes connection of the panel 410 to the housing 402, this does not necessarily need to be the case in all embodiments. Other embodiments may include affixing the panel 414 to the inside of sheathing which makes up the outer shell of the house or other appropriate location.

After testing the box configuration 400, it was found to test at least R-13 and therefore provide an estimated savings for consumers of roughly $2.72 to $3.26 of saved energy per box per year. It is important to remember that the standard non-insulated boxes have typically tested at about at R-value of R-1. The total depth 444 as shown is about 3⅓ inches.

Finally, the interior 448 of the box may be coated with a radiant barrier 450 which may add in the insulating characteristics for at least some embodiments.

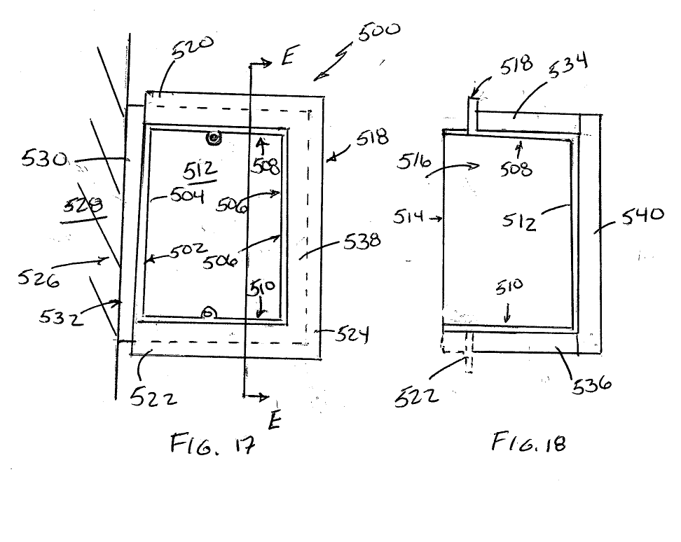

FIG. 17 is another alternative embodiment 500 of a presently preferred embodiment of the present invention in the form of an electrical box 502 having sides 504,506, top 508 and bottom 510 along with back 512. Front 514 is preferably open and leads to internal cavity 516 which would receive a switch outlet, wire connection or other electrical or communication connection therein. These and other embodiments may have voids or other structure therein as well.

Box 502 may have flange 518 such as the three sided flange illustrated with top 520, bottom 522 and side 524. In a presently preferred flange 518, there is no flange portion on the side 526 as it allows for the easy mounting of the box 502 to a stud 528 as illustrated. Of course, flange 518 could extend out to the edge 532 of side insulating panel 530 in some embodiments, if utilized. Bottom flange portion 522 is shown in phantom in FIG. 18 and may not be provided in all of the various embodiments.

Side insulation panel 530 could be the same or different than that shown in various other embodiments. Furthermore, top insulation panel 534, bottom insulation panel 536 and side panel 538 could also be similarly or dissimilarly constructed. The illustrated configuration assists in the reducing a likelihood of thermal shorts through sides 504,506 or top and bottom 508,510 into the electrical box 502. The same concept would hold true for dryer exhaust vents and other structured insulated housings 500. Furthermore, although the top and bottom insulation panels 534,536 are illustrated possibly ending at flange 518 at the top of the box 502, it is alternatively possible to extend all the way to the front 514 as shown in phantom in FIG. 18. Side panels 530,538 may extend to the front 514 in other embodiments as well. Alternatively, it may be possible to utilize a gasket such as gasket 420 shown in FIG. 14, 15 and 16 whether the flange 518 is utilized or not. In fact, if flange 518 is not employed, increased insulative effects may be possible by preventing a possible thermal short through the flange 518. Nevertheless, flange 518 is provided in many embodiments.

While the gasket is not shown in FIGS. 17 and 18, it will be obvious to those of ordinary skill in the art how to install the gasket based on the embodiment shown in FIGS. 14-16. The material utilized for the various insulation panels 530,534,536,538 as well as 540 could be any construction of those described in this reference and others. Furthermore, although the rear panel 540 is shown extending only to the top and bottom of the top and bottom panels 534,536, it would be understood by those of ordinary skill in the art that it could extend as shown in FIGS. 14-16 or others.

It is anticipated that the insulation will be dense foam material for the side panels 534 of the top and bottom panels 534,536 as well as the side panels 530,538 but other materials known in the art could also be utilized. The rear panel 540 will preferably be one of those shown and described throughout this reference.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having thus set forth the nature of the invention, what is claimed herein is:

1. A wall mounted component utilized with electrically powered components in buildings comprising:
a housing at least partially defining a cavity having an internal perimeter, said housing having a rear insulated panel located behind the cavity, said panel spanning at least across a substantial portion of the cavity, said component providing an effective R value of at least about R 6 through the panel and the housing when installed, and said cavity normally providing a location for at least one of a switch, an electrical connection, a communication signal connection, an outlet, and dryer vent exhaust when installed and in use in a building, and said at least one panel having at least one of at least a partial vacuum pressure, air, an insulating gas, aerogel, fibrous insulation, fiberglass and foam therein and a thickness of no more than about ½ inch.

2. The wall mounted component of claim 1 wherein the at least one panel is connected to the housing and extends at least ½ inch beyond at least half of the perimeter of the cavity.

3. The wall mounted component of claim 2 wherein the at least one panel extend at least ¾ inch beyond at least ⅔ of the perimeter of the housing.

4. The wall mounted component of claim 3 wherein the cavity has a top, bottom and sides and the panel extends at least one inch above the top, below the bottom and beyond at least one of the sides.

5. The wall mounted component of claim 1 wherein the component provides a rated R-value of at least R-10.

6. The wall mounted component of claim 1 wherein the panel further comprises aerogel under a vacuum.

7. The wall mounted component of claim 1 further comprising a flange extending from no more than three exterior sides of the housing, said flange receiving an air seal directed towards the front of the housing.

8. The wall mounted component of claim 7 wherein air seal provides a continuous perimeter about the housing.

9. The wall mounted component of claim 8 wherein the air seal has a thickness on a mounting side of the housing corresponding to a distance the panel extends past the housing on the mounting side of the housing.

10. The wall mounted component of claim 9 further comprising a insulated side panel which connects to a side of the housing and to the panel.

11. The wall mounted component of claim 10 wherein the side panel extends from the panel to the air seal and the air seal provides a seal with any of ⅜ inch, ½ inch and ⅝ inch dry wall.

12. The wall mounted component of claim 1 further comprising wire passages providing communication for wires to pass from an exterior of the housing through at least one of the wire passages into the cavity, and a seal provides an air seal against wires extending through wire passages

13. A wall mounted component utilized with electrically powered components in buildings comprising:
a housing at least partially defining a cavity, said housing having a rear insulated panel located behind the cavity, said panel having an effective R value of at least R-6 and spanning at least across a substantial portion of the cavity, said housing directly connected to the panel, and said cavity having an internal perimeter and normally providing a location for at least one of a switch, an electrical connection, a communication signal connection, an outlet, and dryer vent exhaust when installed and in use in a building, said panel extending at least ½ inch beyond at least two of a top, a first side, and a bottom of the internal perimeter of the cavity.

14. The wall mounted component of claim 13 wherein said panel extends at least one inch beyond the at least two of the top, bottom, and first side of the internal perimeter of the cavity.

15. The wall mounted component of claim 13 further comprising a flange extending from no more than the top, bottom and first side of the housing and an air seal extending forward of the gasket, said air seal providing a continuous perimeter about the cavity.

16. The wall mounted component of claim 13 wherein the panel further comprises at least one of at least a partial vacuum pressure, a gas, air, aerogel, fibrous insulation, fiberglass and foam retained therein and the panel extends past a second side of the housing substantially a similar distance as the air seal extends past the second side.

17. The wall mounted component of claim 16 further comprising an insulating side panel connected to the housing extend forward from the panel along the second side of the housing.

18. The wall mounted component of claim 17 wherein the side panel has a thickness of at least about ¼ inch and extends flush to the side of the panel.

19. The wall mounted component of claim 18 wherein the side panel extends flush with the airs seal at the second side of the panel.

20. The wall mounted component of claim 13 wherein the panel has a thickness of less than about ¾ inch.
